(19) United States
(12) Patent Application Publication
(10) Pub. No.: US 2008/0299534 A1
(43) Pub. Date: Dec. 4, 2008

(54) Training apparatus for servicing domestic appliances

(76) Inventor: Jesse Richardson, Chicago, IL (US)

Correspondence Address: THE LAW OFFICE OF RANDALL T. ERICKSON, P.C., 1749 S. NAPERVILLE ROAD, SUITE 202, WHEATON, IL, 60187, US

(21) Appl. No.: 11/809,209

(22) Filed: May 31, 2007

(51) Int. Cl. G09B 9/00

(52) U.S. Cl. 434/383; 434/382

(57) ABSTRACT

A method of manufacturing a service technician training apparatus for domestic appliance servicing comprises severing conductors within an actual appliance and connecting severed ends of the conductors to controllable switches. The training apparatus can include a plurality of the switches mounted on an instructor's console that is arranged to be obscured from view by the student that is troubleshooting the appliance.

### TECHNICAL FIELD OF THE INVENTION

The present invention relates to training apparatus for service personnel who repair domestic appliances.

### BACKGROUND OF THE INVENTION

It is known to provide simulated appliances for training service personnel to troubleshoot malfunctioning appliances to determine the malfunction.

U.S. Pat. No. 4,623,312 discloses a changeable modular electrical control training system to provide hands-on training in the servicing and troubleshooting of electrical control systems. The system comprises a plurality of structural electro-mechanical cubes that are removably attached to a structural power base or alternatively to an operating mechanical refrigeration training system (E.L.R.T.) Each of the cubes is adapted for combined mechanical and electrical connection to the power base or alternatively to another cube.

The various cubes include simulators, controllers and source cubes to represent components of a field control system. Each of the cubes includes conventional electromechanical components which function similarly to the systems encountered in the field. Wiring inside the cubes establishes indicator light power circuitry and control system circuitry.

The internal wiring in the cubes for control system circuitry is completed by the student using external patch cords to connect the cubes according to the instructor designed control circuit. Faults or failures are entered into the control system circuitry by the instructor, using instructor-controlled fault switches, to provide the student with troubleshooting problems that he or she must correct after establishing the location of these faults using conventional testing equipment.

However, the cube system in U.S. Pat. No. 4,623,312 presents to the student a “representation” of a control system and not an actual control systems such as present on an actual furnace. The components analyzed by the students and the immediate environment of the components are not identical to what the student would encounter in the field.

The present inventor has recognized that it would be desirable to provide a portable training system which would allow the students to troubleshoot an actual control system of a domestic appliance.

The present inventor has recognized that it would be desirable to provide a training apparatus for a domestic appliance that replicated, to the greatest extent possible, the conditions that a field service technician would face in troubleshooting an actual malfunctioning domestic appliance.

### SUMMARY OF THE INVENTION

The present invention provides a training apparatus and a method of manufacturing a training apparatus.

According to the preferred embodiment, a plurality of switches are provided on an instructor's console or back panel of the apparatus wherein an instructor can select in which circuit of the appliance to simulate a failure by opening the corresponding switch, the selection being hidden from observation by the student. The student must thereafter troubleshoot the appliance to determine the location and nature of the fault without knowing which switch or switches haves been selected by the instructor to simulate a fault or faults.

The apparatus of the invention comprises an actual domestic appliance such as a furnace, air-conditioner, water heater, oven or refrigerator that is modified to have open circuits that are closable by a plurality of switches located on a back panel or instructor's console that is hidden from view of the student. The instructor is able to selectively simulate an open circuit in many of the appliance circuits, particularly those circuits that are prone to failure in the field.

The method includes the steps of providing an actual domestic appliance and modifying the appliance by disconnecting circuits and reconnecting circuits via wires and switches such that the circuits can be selectively opened by an instructor to simulate failure of a circuit. The method can also include the step of adding a resistance to the circuit via the switch and a resistor to simulate a partial failure or a weakened component. The method can also include the step of closing a circuit to simulate a short circuit.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a perspective view of a heating, ventilating and air conditioning unit (HVAC) embodiment of the present invention;

FIG. 2 is a rear view of the HVAC embodiment of FIG. 1;

FIG. 3 is a fragmentary front view of the HVAC embodiment shown in FIG. 1;

FIG. 4 is an enlarged fragmentary front view of an instructor's console as shown in FIG. 3;

FIG. 5A is a schematic diagram of furnace and ventilating units of the HVAC embodiment of FIG. 1;

FIG. 5B is a schematic diagram of a condenser unit of the HVAC embodiment of FIG. 1;

FIG. 5C is a portion of the schematic diagram of the furnace and ventilating units of FIG. 5A;

FIG. 6 is a legend for the diagram of FIG. 5A;

FIG. 7A is a schematic diagram of a switch arrangement;

FIG. 7B is an alternate schematic diagram of a switch arrangement;

FIG. 7C is a further alternate schematic diagram of a switch arrangement;

FIG. 8 is a schematic diagram of a water heater embodiment of the invention;

FIG. 9 is a schematic diagram of an oven embodiment of the invention; and

FIG. 10 is a schematic diagram of a refrigerator embodiment of the present invention.

### DESCRIPTION OF THE PREFERRED EMBODIMENT

While this invention is susceptible of embodiment in many different forms, there is shown in the drawings and will herein be described in detail preferred features of the invention. It will be understood, however, that the present disclosure is to be considered as an exemplification of the principles of the invention and is not intended to limit the invention to the specific form of the combination of features that are illustrated and described.

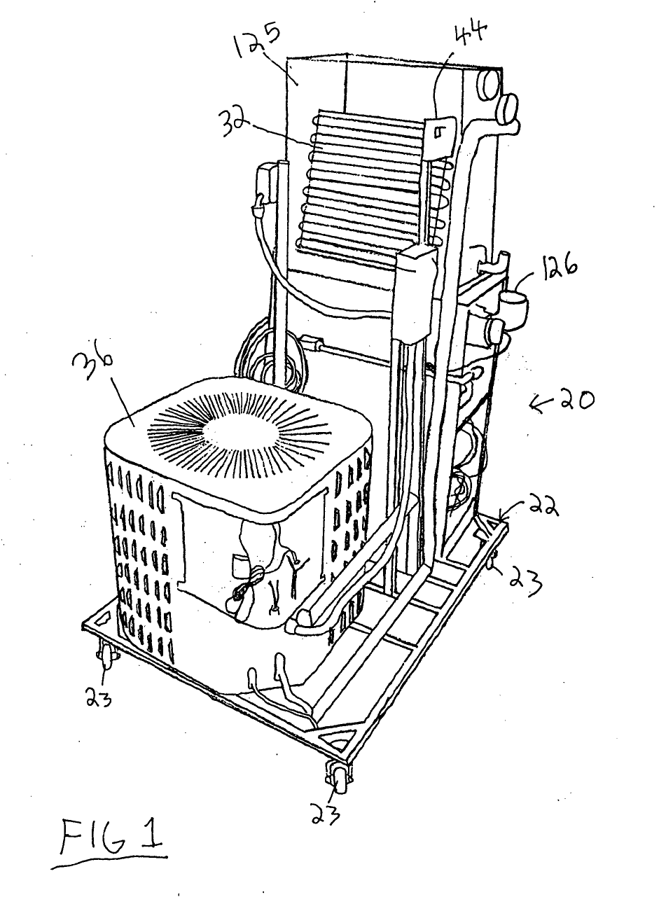

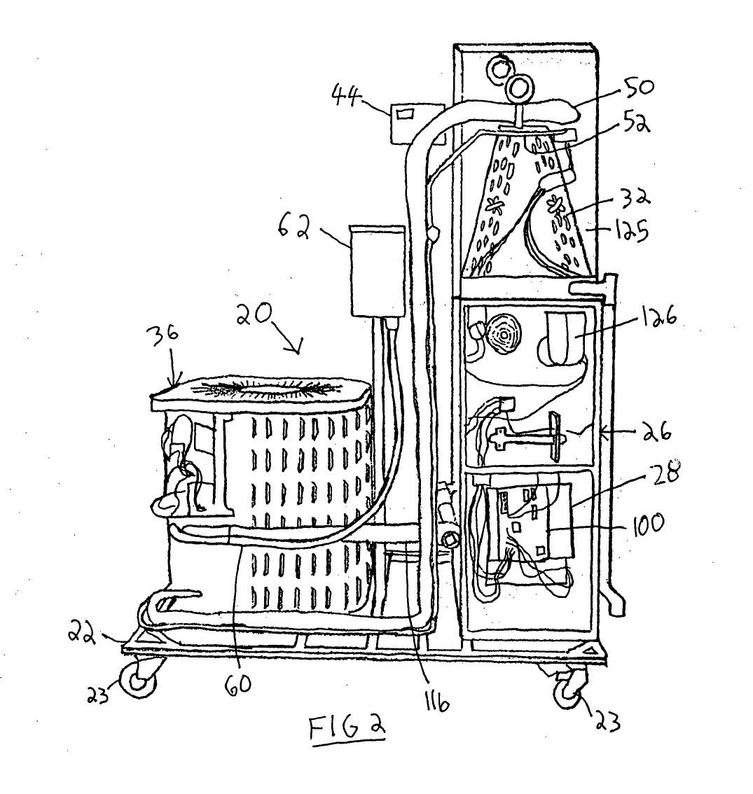

FIG. 1 illustrates a domestic appliance such as a central heating, ventilating and air-conditioning apparatus (HVAC) 20 of the present invention. The term “domestic” is meant to infer that the appliance would be of the type which could be found in a home or office. The apparatus 20 is substantially identical to a domestic HVAC apparatus such as would be found in a typical home.

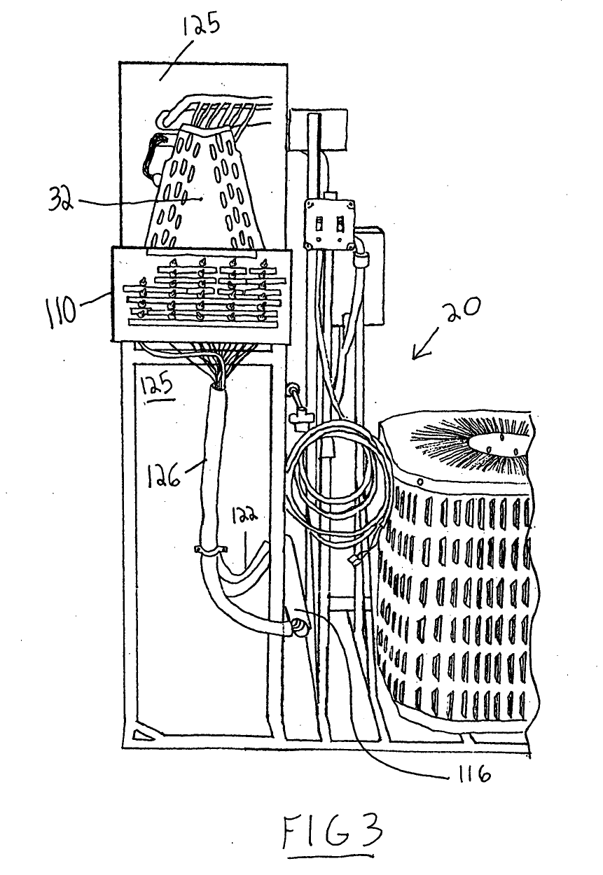

FIG. 2 illustrates a back side of the apparatus 20 with a sheet metal cover removed. The apparatus 20 includes a gas powered furnace unit 26, a ventilating or fan unit 28 including a forced air fan, a cooling evaporator unit 32, a cooling condenser unit 36 including a refrigerant compressor and an evaporator fan, and a thermostat 44. The apparatus 20 is mounted on a cart 22 that is supported on caster wheels 23.

The condenser unit 36 is piped to the evaporator unit 32 via tubes 50, 52 and other components as is known in conventional central air conditioning systems. The tube 50 is shown insulated. The condenser unit 36 is wired for power and control via wires threaded through a conduit 60 and a junction box 62, as would be found at a typical house installation.

The furnace unit 26 includes a control printed circuit board 100 having electronic components mounted thereon and which constitutes a central processing unit (CPU).

According to the invention, the apparatus 20 is modified to provide the capability to cause pre-selected electrical or electronic faults in the control or power circuits for the furnace, cooling and/or ventilating systems.

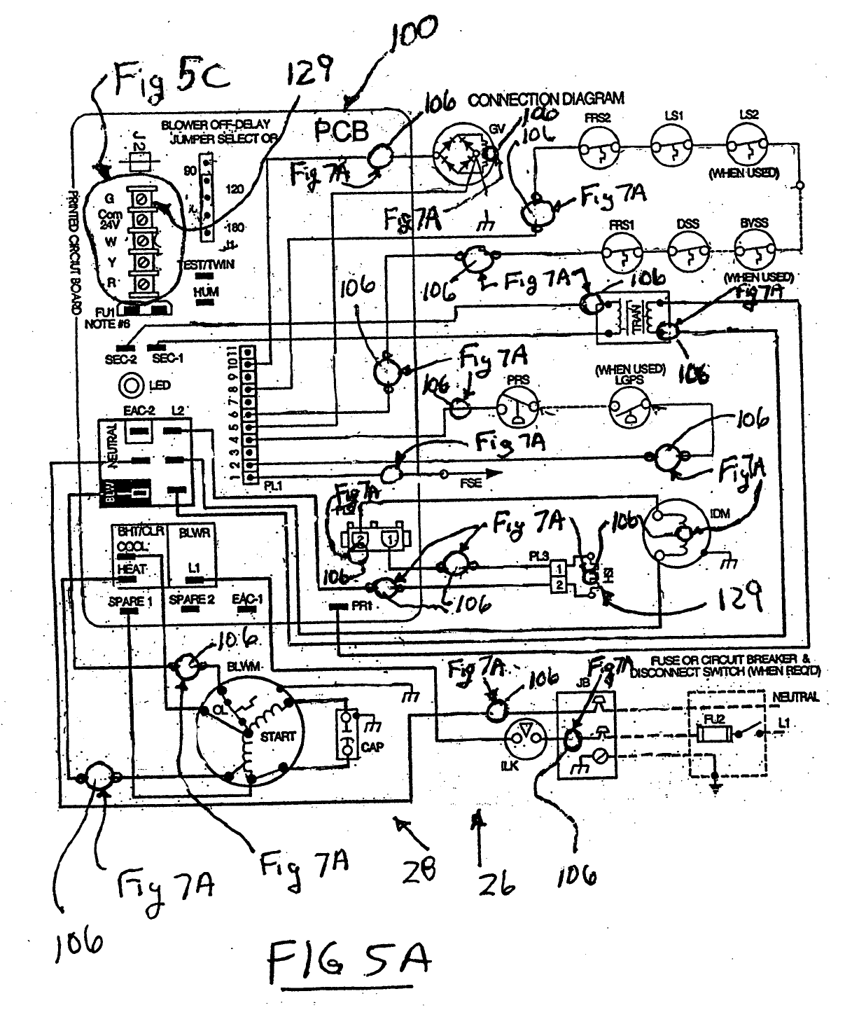

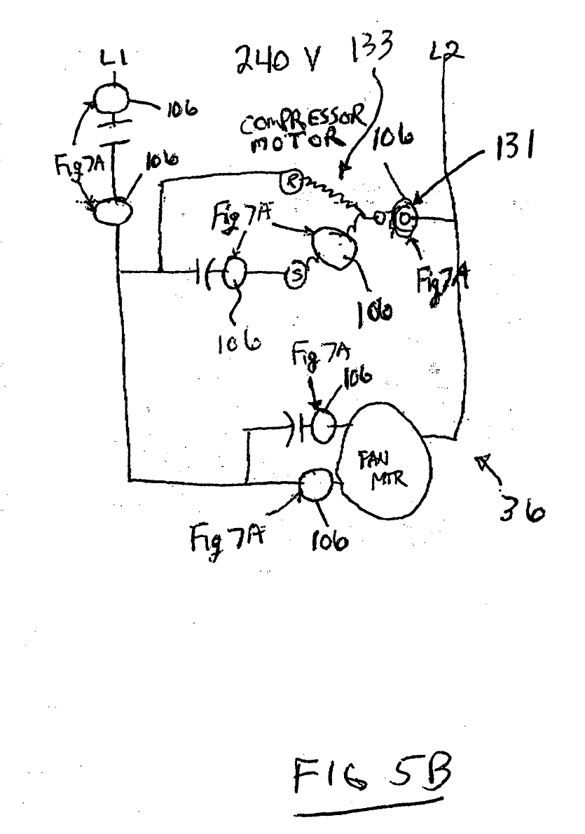

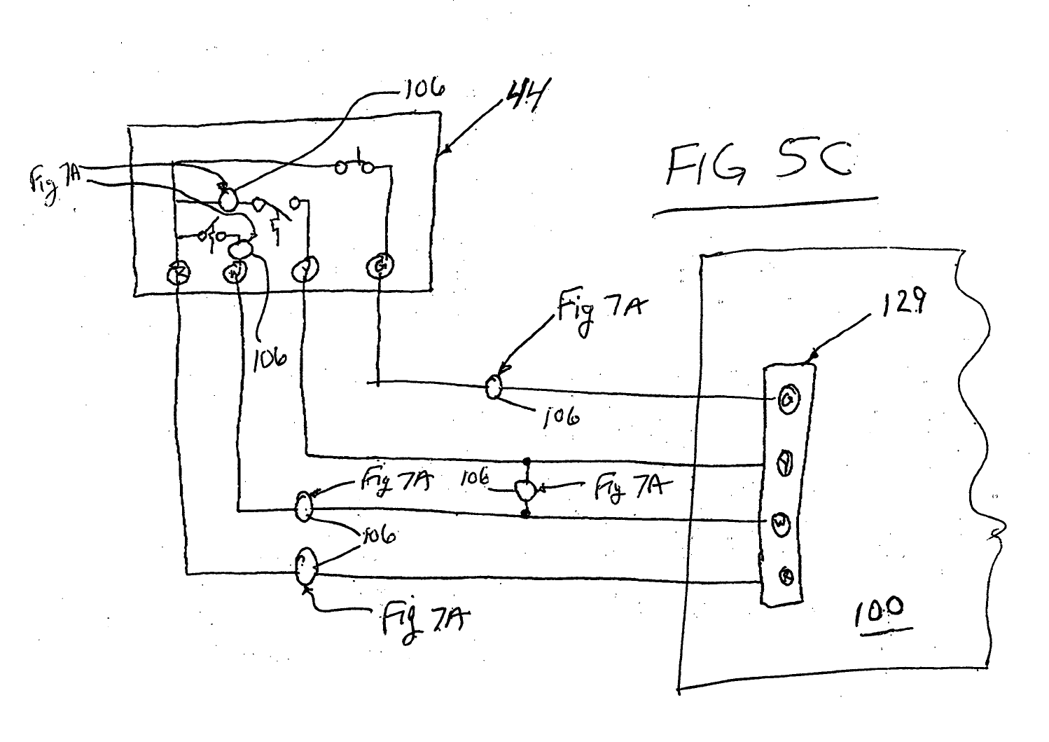

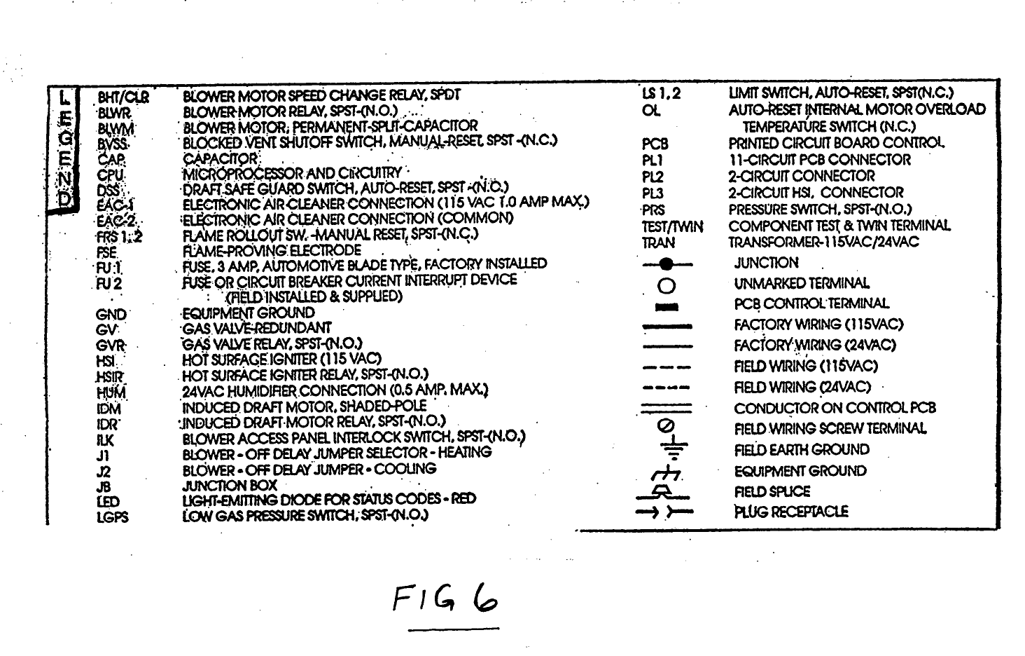

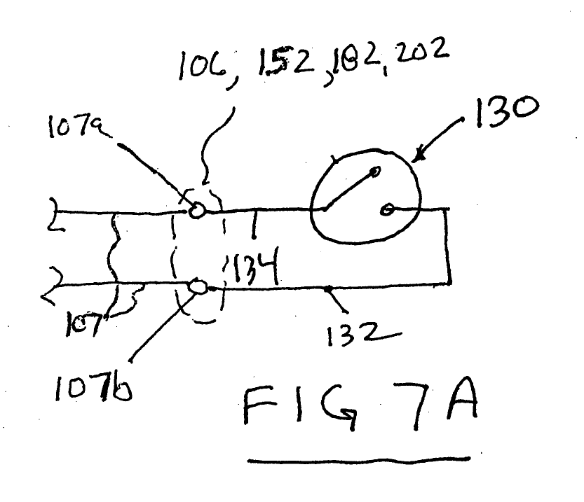

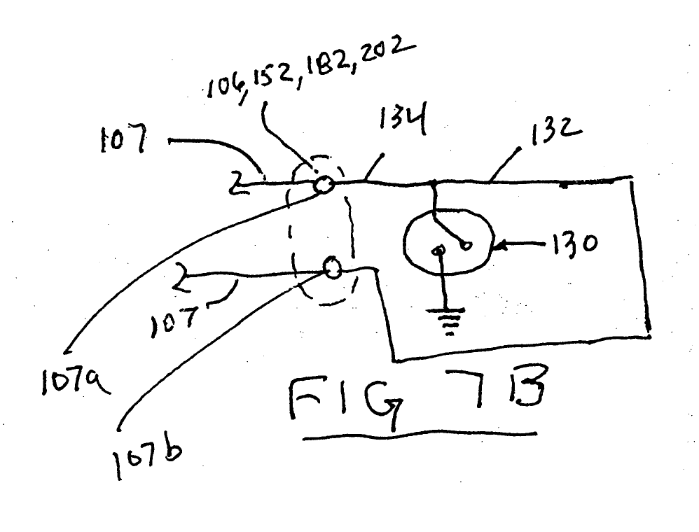

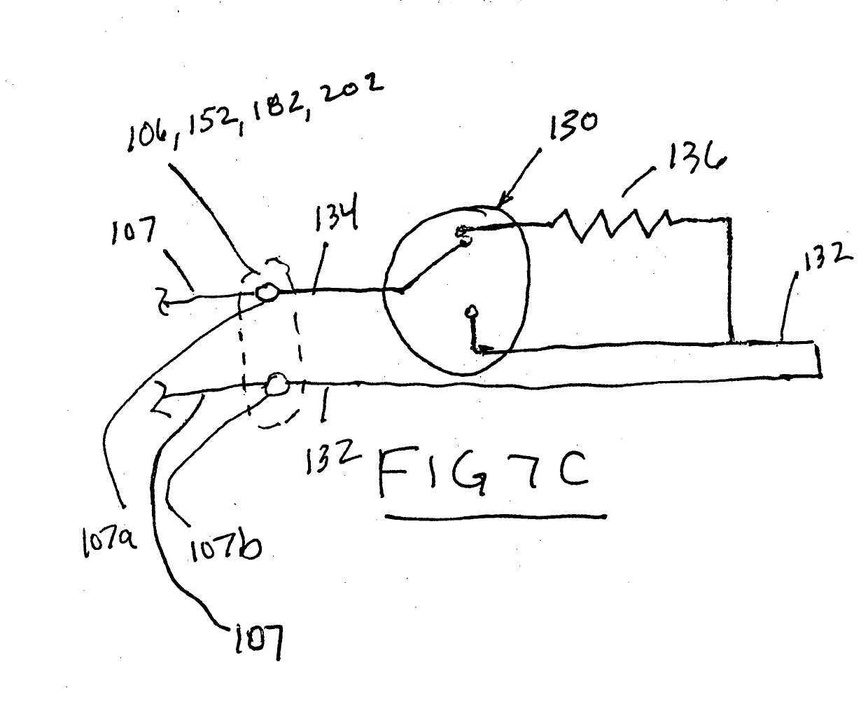

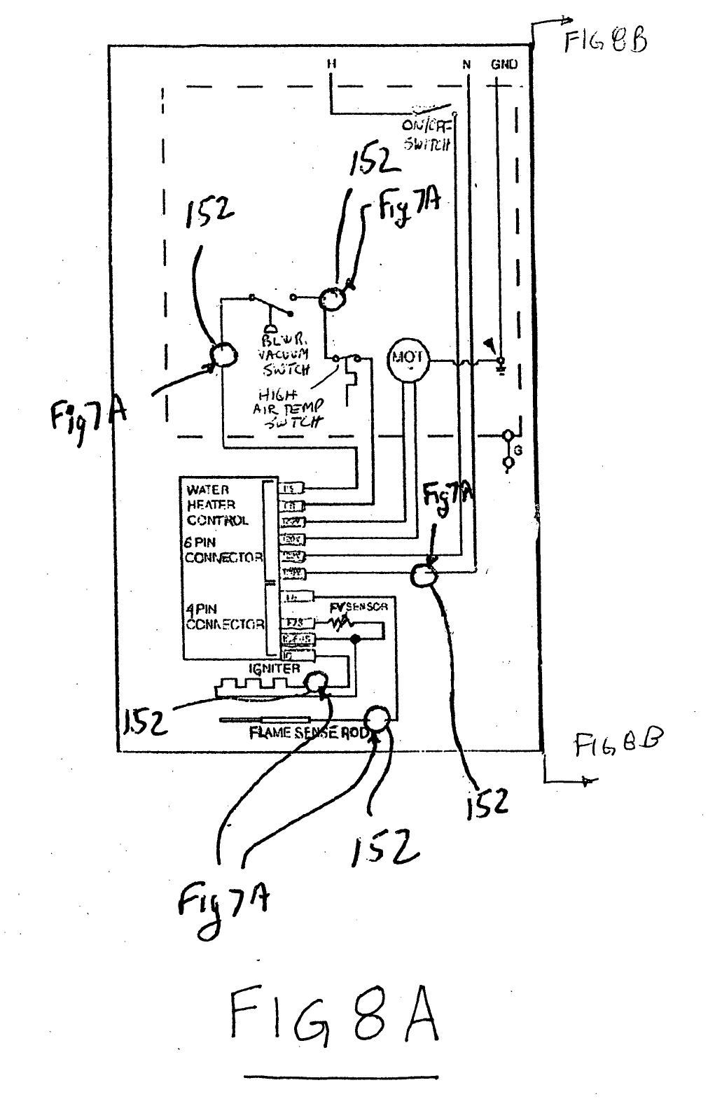

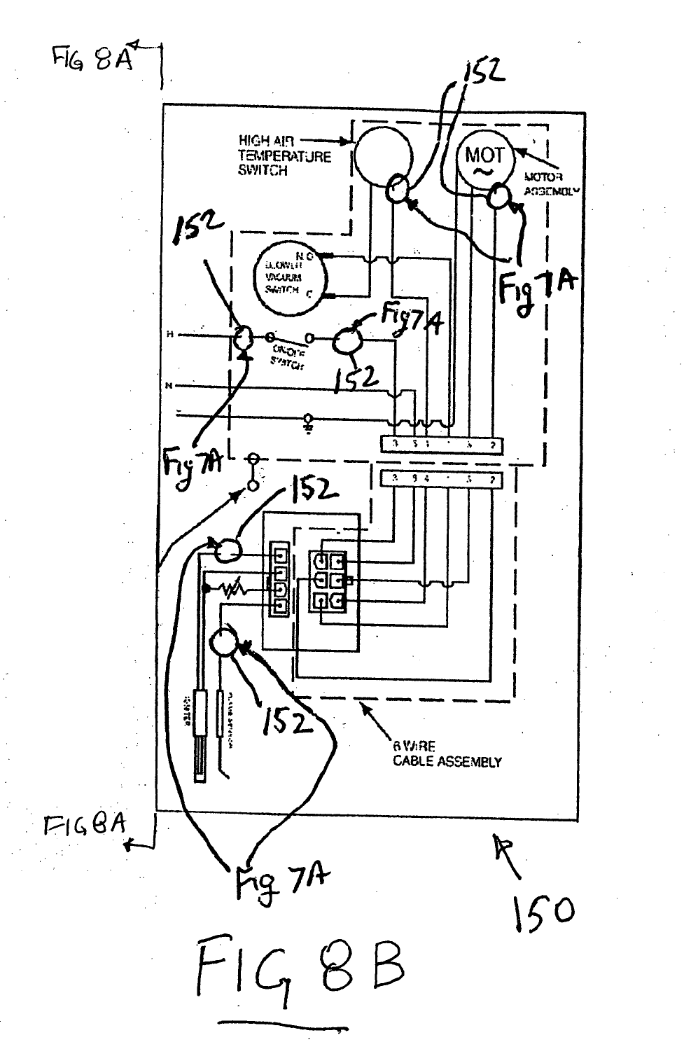

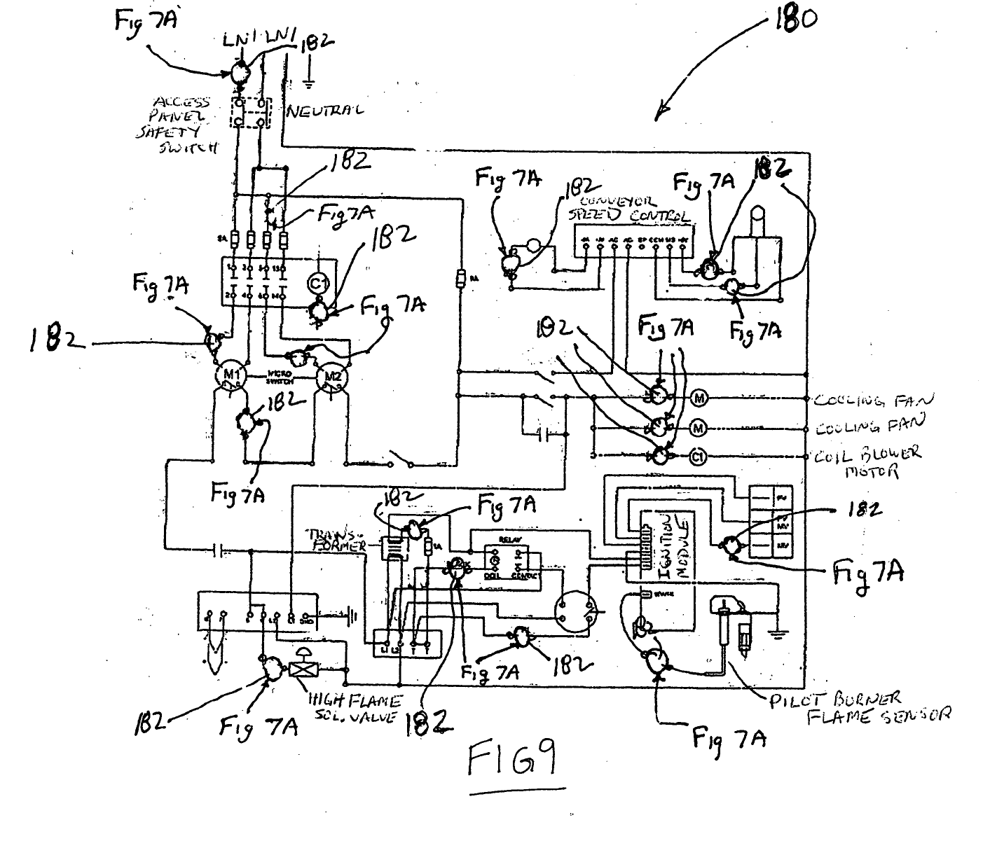

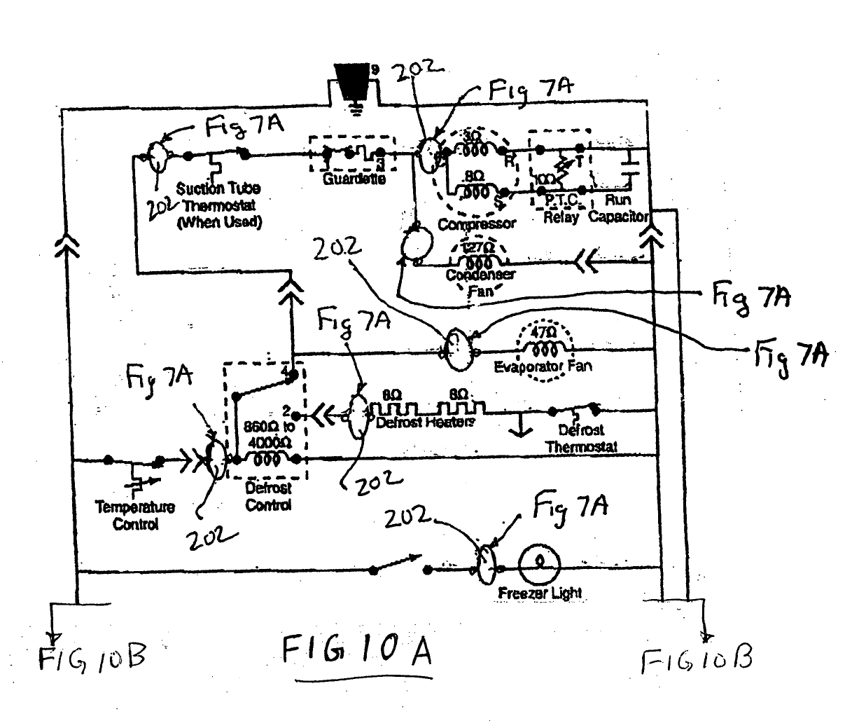

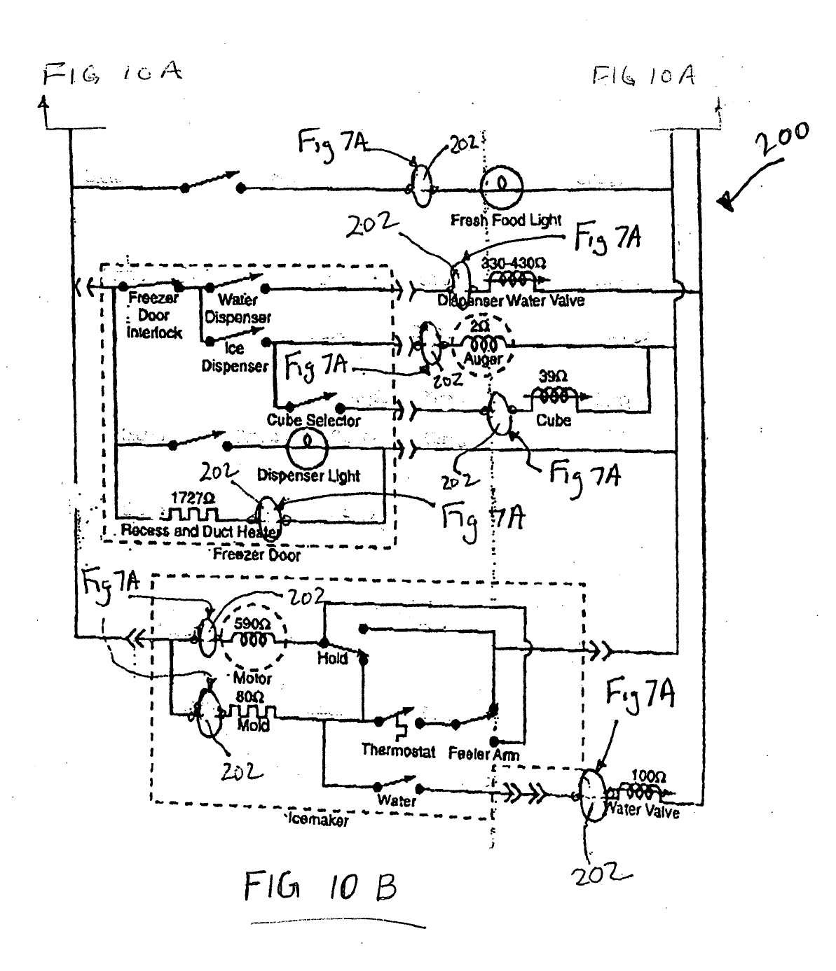

According to the invention, conductors 107 within the control or power circuits, or within components, are intentionally disconnected or severed at test connections 106 (FIGS. 5A and 5B) creating a pair of severed ends 107a, 107b (FIGS. 7A, 7B, 7C) wherein test wires are connected on each side of the disconnection, to each of the ends 107a, 107b and routed to an instructor's console 110 in front of the apparatus 20. The instructor's console is located such that the student cannot observe the console while working at the back side of the apparatus.

The test connections 106 can be located within wiring, conductors on the printed circuit board or within components, such as within a winding of a motor.

The test wires for the condenser unit 36 are routed to the instructor's console 110 via a conduit 116. The test wires for the furnace 26 and ventilation unit 28 are routed through a front panel of the furnace through a conduit or wire guide 122. The conduit 116, 122 merge into a conduit or wire guide 126 that extends up to the instructor's console 110.

FIGS. 1-3 illustrate that the apparatus 20 is substantially identical to a commercially available HVAC unit. In that regard the evaporator unit 32 is mounted within an actual air plenum or duct 125 above the fan unit 28. The furnace unit 26 is also located within the plenum or duct between the evaporator unit 32 and the fan unit 28. The furnace unit includes an exhaust vent 126.

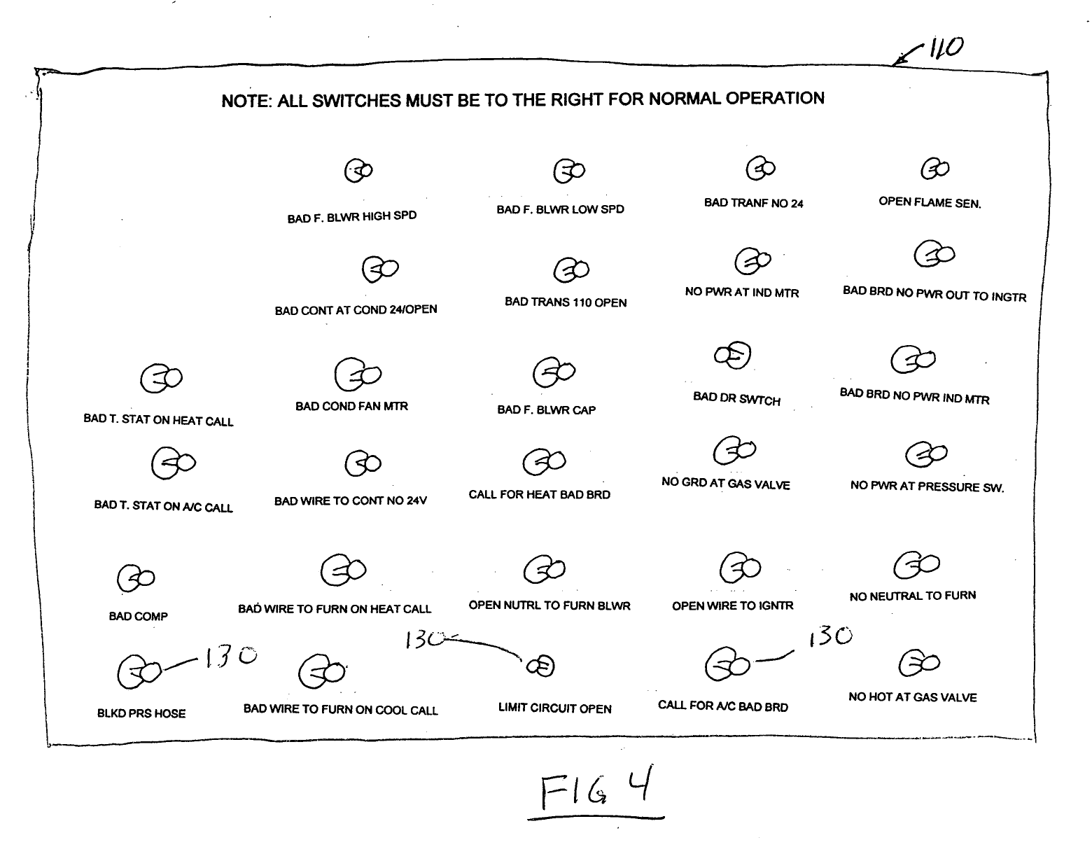

FIG. 4 illustrates the instructor's console 110 having (28) toggle switches 130 that can be used to initiate faults in the control and power circuits of the apparatus 20. The following faults can be initiated:

bad thermostat on heat call,

bad thermostat on air-conditioning call,

bad compressor,

blocked pressure hose,

bad fan blower, high speed,

bad contact at condenser 24/open,

bad condenser fan motor,

bad wire to contact number 24V,

bad wire to furnace on heat call,

bad wire to furnace on cool call,

bad fan blower, low speed,

bad transformer 110 open,

bad fan blower capacitor,

call for heat, bad board,

open neutral to furnace blower,

limit circuit open,

bad transformer number 24,

no power at induction motor,

bad dr switch,

no ground at gas valve,

open wire to igniter,

call for air-conditioning bad board,

open flame sensor,

bad board, no power to igniter,

bad board, no power to induction motor,

no power at pressure switch,

no neutral lead connection to furnace, and

no hot lead connection at gas valve.

FIG. 5A illustrates places on a furnace unit and ventilating unit connection schematic where the test connections 106 can be made. At each location 106, the connection detail shown in FIG. 7A can be used. Wiring between components can have a test connection or conductors within components can have a test connection such as igniter 129. Component casings can be opened and test connections created on component conductors.

FIG. 5B illustrates places on a condenser unit schematic where the test connections 106 can be made. At each location 106, the connection detail shown in FIG. 7A can be used. Wiring between components can have a test connection or conductors within components can have a test connection such as internal overload trip 131 within compressor motor 133. Component casings can be opened and test connections created on component conductors.

FIG. 6 comprises a legend for the symbols used in FIG. 5A.

FIG. 5C illustrates in detail the connections from a thermostat terminal strip 129 to the thermostat 44. The connections 106 can me made at locations in the wiring from the furnace circuit board 100 to the thermostat 44, between wires, and within wiring internal to the thermostat 44. The connections 106 can be according to FIG. 7A or alternately FIG. 7B or 7C. Thus, faults can be simulated in the wiring external to the circuit board 100 or thermostat 44 or as a component failure of the thermostat 44. To simulate the latter, the thermostat is opened up and wires or circuit board conductors are cut or severed and the connections according to FIG. 7A or alternately FIG. 7B or 7C are made.

FIG. 7A illustrates how each toggle switch 130, such as each of the (28) toggle switches 130 shown in FIG. 4, is placed into the test connection 106. A test wire 132 and a test wire 134 are connected to the switch 130 below the console 110 and are routed to the respective severed conductor ends 107a, 107b corresponding to the test connections 106 shown in FIGS. 5A and 5B. Depending on the state or position of the switch 130, the conductor ends 107a, 107b are effectively disconnected (open circuited) at the switch 130 or connected through the switch 130.

FIG. 7B illustrates an alternate embodiment to the arrangement of FIG. 7A wherein one a more of the test locations 106 shown in FIGS. 5A and 5B can be selectively shorted to ground rather than severed.

FIG. 7C illustrates a further alternate embodiment to FIG. 7A wherein one or more of the conductors at the test locations 106 shown in FIGS. 5A and 5B can have a resistor 136 added. This could simulate a faulty or weakened component, or a bad connection.

FIG. 8 illustrates a schematic for a domestic appliance in the form of a water heater 150. Test connections 152 are illustrated and can also use the switch and wiring configuration shown in FIG. 7A, or alternately FIG. 7B or 7C as applicable.

FIG. 9 illustrates a schematic for a domestic appliance in the form of an oven 180. Test connections 182 are illustrated and can also use the switch and wiring configuration shown in FIG. 7A, or alternately FIG. 7B or 7C as applicable.

FIG. 10 illustrates a schematic for a domestic appliance in the form of a refrigerator/freezer 200. Test connections 202 are illustrated and can also use the switch and wiring configuration shown in FIG. 7A, or alternately FIG. 7B or 7C as applicable.

According to the each of the embodiments described above, the plurality of switches 130 allow an instructor to select in which circuit of the appliance to simulate a failure by changing the state of the corresponding switch, the selection being hidden from observation by the student.

The apparatus of the invention comprises an actual domestic appliance such as a furnace, air-conditioner, HVAC unit, water heater, oven or refrigerator that is modified to have open circuits, bad connections or short circuits that are selectable by a plurality of switches located on a back panel or instructor's console that is hidden from view of the student.

To further enhance the training of the student, an actual appliance is utilized wherein the environment is identical to what the student would face when making a field service call to repair a malfunctioning appliance. The method of the invention includes the steps of providing an actual domestic appliance and modifying the appliance by disconnecting circuits and reconnecting circuits via wires and switches such that the circuits can be selectively opened by an instructor to simulate failure of a circuit. The disconnections can be within wiring, within conductors on a printed circuit board, or within individual components, such as within windings of a motor. The method can also include the step of adding a resistance to the circuit via the switch and a resistor to simulate a partial failure or a weakened component. The method can also include the step of closing a circuit to simulate a short circuit.

From the foregoing, it will be understood that numerous variations and modifications may be effected without departing from the true spirit and scope of the novel concept of the invention. It is to be understood that no limitation with respect to the specific method, apparatus, and product illustrated herein is intended or should be inferred. It is, of course, intended to cover by the appended claims all such modifications as fall within the scope of the claims.

The invention claimed is:

1. A method of manufacturing a service technician training apparatus for domestic appliance servicing, comprising the steps of:
providing an actual domestic appliance having electrical conductors;
providing a plurality of controllable switches;
severing a plurality of said conductors and creating a plurality of severed end pairs; and
connecting each respective severed end pairs of said conductors to one of said controllable switches.

2. The method according to claim 1, wherein said step of providing a plurality of controllable switches is further defined by the steps of:
mounting said plurality of controllable switches on an instructor's console; and
locating said instructor's console on said training apparatus at a position wherein a position of said plurality of switches is not observable by a student troubleshooting said domestic appliance.

3. The method according to claim 1, wherein said step of providing a domestic appliance is further defined in that said domestic appliance comprises a furnace.

4. The method according to claim 1, wherein said step of providing a domestic appliance is further defined in that said domestic appliance comprises an air-conditioning unit.

5. The method according to claim 1, wherein said step of providing a domestic appliance is further defined in that said domestic appliance comprises a refrigerator.

6. The method according to claim 1, wherein said step of providing a domestic appliance is further defined in that said domestic appliance comprises an oven.

7. The method according to claim 1, wherein said step of providing a domestic appliance is further defined in that said domestic appliance comprises an HVAC apparatus.

8. The method according to claim 1, wherein said step of providing a domestic appliance is further defined in that said domestic one is comprises a water heater.

9. A training apparatus for domestic appliance servicing, comprising:
a domestic appliance having electrical conductors, said electrical conductors being modified to have disconnections creating severed end pairs;
a plurality of switches; and
test wiring electrically connecting each said severed end pair to one switch of said plurality of switches.

10. The apparatus according to claim 9, wherein said plurality of switches are mounted on an instructor's console.

11. The apparatus according to claim 10, wherein said switches comprised toggle switches.

12. The apparatus according to claim 9, wherein said switches comprised toggle switches.

13. The apparatus according to claim 9, wherein at least one of said conductors comprises a printed circuit board conductor.

14. The apparatus according to claim 9, wherein at least one of said conductors comprises a motor winding.

15. The apparatus according to claim 9, wherein said domestic appliance comprises a furnace.

16. The apparatus according to claim 9, wherein said domestic appliance comprises an air-conditioning unit.

17. The apparatus according to claim 9, wherein said domestic appliance comprises a water heater.

18. The apparatus according to claim 9, wherein said domestic appliance comprises a refrigerator.

19. The apparatus according to 9, wherein said domestic appliance comprises an oven.

20. The apparatus according to claim 9, wherein said domestic applied comprises an HVAC unit.
